(19) United States
(12) Patent Application Publication
(10) Pub. No.: US 2016/0210873 A1
(43) Pub. Date: Jul. 21, 2016

(54) USER PERFORMANCE SKILL ENHANCEMENT BASED ON CURRICULAR MAPPING

(71) Applicant: EDSIX BRAIN LAB P. LTD, Chennai (IN)

(72) Inventors: Saravanan Sundaramoorthy, Chennai (IN); Kalpana Murthy, Chennai (IN)

(73) Assignee: Edix Brain Lab Private Limited, Chennai (IN)

(21) Appl. No.: 14/913,871

(22) PCT Filed: Aug. 25, 2014
(86) PCT No.: PCT/IN2014/000544

§ 371 Date: Feb. 23, 2016

(30) Foreign Application Priority Data
Aug. 23, 2013 (IN) 3732/CHE/2013

(51) Int. Cl. G09B 19/00; G09B 5/02

(52) U.S. Cl. CPC G09B 19/00; G09B 5/02

(57) ABSTRACT

The embodiments herein provide a training system and method for user performance skill enhancement based on curricular mapping. The method includes displaying a first level of a first simulation eliciting a response from the user, wherein the first level corresponds to at least one curricular activity in real-world for which the training is desired. Further, the method includes computing a performance data of the user for the first level using the response from the user. Further, the method includes determining a second level based on the computed performance data, wherein the second level is dynamically created based on at least one parameter associated with the user. Furthermore, the method includes presenting the second level to the user, wherein the second level is associated with at least one of the first simulation and a second simulation.

### FIELD OF INVENTION

This invention relates to training systems and more particularly to a training system and method for user performance skill enhancement based on curricular mapping. The present application is based on, and claims priority from Indian Application Number 3732/CHE/2013 filed on 23 Aug. 2013, and PCT/IN2014/000544 filed on 25 Aug. 2014, the disclosures of which are hereby incorporated by reference.

### BACKGROUND

As video-game or simulations playing has become a ubiquitous activity in today's society, it is worth considering its potential consequences on an individual performance skill Some video-game training shows a significant effect of playing certain types of games to improve the performances of other untrained tasks, which can be commonly designated as a transfer effect. Generally, the improvements of cognitive functions through playing video-games can refer as the transfer effect.

Different systems and methods are proposed for training and enhancing the individual performance skill This is accomplished by presenting complex game to the individual and measuring the individual response throughout the game. The conventional systems and methods include general concept or activity in the games to measure the individual's performance, which may be ineffective to efficiently improve the individual performance skills when compared with curricular activities of the individual in real-time. Further, the video-games can provide an enjoyable and socially connected competitive experience for a group of individuals. Thus, it would be desirable to consider the individual curricular activities or concepts in the simulations and also to provide a means for allowing the individuals to asynchronously compete with each other in order to effectively improve the individual's ability to perform a particular task in real-world.

### SUMMARY

The principal object of this invention is to provide a system and method of training a user based on curricular mapping.

Another object of the invention is to provide a system and method for enhancing performance skill of in performing a particular task in real-world based on the user curricular mapping.

Yet another object of the invention is to provide a mechanism for dynamically creating a plurality of simulations including a plurality of levels each corresponding based on user curricular activities.

Yet another object of the invention is to provide a mechanism for assessing performance of a user in performing a specific task.

Yet another object of the invention is to provide a mechanism for allowing the individuals to asynchronously compete with each other.

Accordingly, the embodiments herein achieve a method for training a user for performance skill enhancement based on curricular mapping. The method includes presenting a first level of a first simulation eliciting a response from the user, wherein the first level corresponds to at least one curricular activity in real-world for which the training is desired. Further, the method includes computing a performance data of the user for the first level using the response from the user. Further, the method includes determining a second level based on the computed performance data, wherein the second level is dynamically created based on at least one parameter associated with the user. Furthermore, the method includes presenting the second level to the user, wherein the second level is associated with at least one of the first simulation and a second simulation.

The embodiments herein achieve a system for training a user for performance skill enhancement based on curricular mapping. The system is configured to include a simulation engine configured to present a first level of a first simulation eliciting a response from the user, wherein the first level corresponds to at least one curricular activity in real-world for which the training is desired. Further, the simulation engine is configured to compute a performance data of the user for the first level using the response from the user. Further, the simulation engine is configured to determine a second level based on the computed performance data, wherein the second level is dynamically created based on at least one parameter associated with the user. Furthermore, the simulation engine is configured to present the second level to the user, wherein the second level is associated with at least one of the first simulation and a second simulation.

Accordingly the embodiments herein provide a computer program product including a computer executable program code recorded on a computer readable non-transitory storage medium, the computer executable program code when executed causing the actions including presenting a first level of a first simulation eliciting a response from a user, wherein the first level corresponds to at least one curricular activity in real-world for which the training is desired. Further, the computer executable program code when executed causing the actions including computing a performance data of the user for the first level using the response from the user. Further, the computer executable program code when executed causing the actions including determining a second level based on the computed performance data, wherein the second level is dynamically created based on at least one parameter associated with the user. Furthermore, the computer executable program code when executed causing the actions including presenting the second level to the user, wherein the second level is associated with at least one of the first simulation and a second simulation.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a diagram that illustrates a high level architecture of a system in which the present invention is embodied, according to embodiments as disclosed herein;

FIG. 2 is a flow chart that illustrates a method for creating simulations on a server, according to embodiments as disclosed herein;

FIG. 3 is an example illustration of the method described in the FIG. 2, according to embodiments as disclosed herein;

FIGS. 4a, 4b, 4c, 4d, 4e, and 4f are example illustrations showing some of the simulations created by a simulation engine, according to embodiments as disclosed herein;

FIG. 5 is a flow chart that illustrates a method for training a user based on curricular mapping, according to embodiments as disclosed herein;

FIGS. 6a, 6b, 6c, and 6d are example illustrations of a report generated for simulations played by the user, according to embodiments as disclosed herein;

FIG. 7 is a flow chart that illustrates a method for providing recommendations and allowing users to asynchronously compete with each other, according to embodiments as disclosed herein; and

FIG. 8 illustrates a computing environment implementing the method and system as disclosed in the embodiments herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Prior to describing the present invention in detail, it is useful to provide definitions for key terms and concepts used herein. Unless defined otherwise, all technical and scientific terms used herein have the same meaning as commonly understood by one of ordinary skill in the art to which this invention belongs.

The term “simulation”, non-exclusively, refers to an interactive multimedia corresponding to real-world entity having dynamic elements that may be controlled by a user. In some embodiment, the term “simulation’ may refers to imitation of the operation of a real-world activities over time in the form of an interactive multimedia by combining strategy and skills along with a game. In an embodiment, the simulations can represent any real-world curricular or regular activities may be present, past, or future, of a user.

Curricular activity: May refers to a planned interaction of pupils that they typically undergo in real-world. In an embodiment, the curricular activity may refer to activities that enable to supplement or complement the curricular or main syllabi activities in real-word.

The embodiments herein disclose a system and method for training a user based on curricular mapping. A plurality of simulations are created and stored in a server, where each simulation includes plurality of levels indicating the user curricular activities. Unlike conventional system, each level of the simulation includes curricular activity or concept, such as to effectively enhance the user ability to perform a particular task in real-time. The sever can be configured to present an first level associated with a simulation eliciting a response from the user. A performance for the first level can be computed based on the response received from the user. In an embodiment, the performance can be computed using response time and the correctness of the response provided by the user. Further, the server can be configured to dynamically determine and generate a second level for the user based on the computed performance and at least one parameter associated with eh user. Further, the server is configured to present the second level to enhance the performance skill of the user, wherein the second level can be a next level of the first simulation or can be a level associated with a second simulation.

Furthermore, the server can be configured to generate a report about the performance of the user at each level associated with the one or more simulations. Furthermore, the server can be configured to allow the user to track and analyze the performance of the user at each level using a plurality of rules, such as to provide recommendations about other simulations. Furthermore, the server can be configured to compare the performances of the user with other performances of one or more other users, such as to provide recommendation message for the user to enhance their skills of future simulation performances over their current performance.

The proposed system and method is simple, reliable, dynamic, and robust for assessing, training, and improving the user ability to perform a particular task. Unlike conventional system, the present invention provides a controlled simulating experience to enhance the performance skill of the user based on the curricular mapping. The server builds the simulations based on the real-world curricular activities of the user in order to effectively improve the user ability to perform a particular task in real-time. The system and method can be used to improve the brain-based processing skill, perceptual skill, auditory skill, cognitive skills, and the like skills of the user.

For instance, to a greater extent, the theoretical knowledge of students gets strengthened when a relevant simulation is undergone corresponding to real-world activity of the content taught in a class room. When the user combines strategy and skills to complete and compete with other user at different levels of the simulations over a period of time, then they can improve their accuracy, speed of calculations, analysis power, alertness, concentration, efficiency, and the like. Further, as the simulations can provide an enjoyable and socially connected competitive experience for a group of individuals, it is important to compare the performances of different users to improve cognitive functions and achieve an improvised performance in competition to others. The system and method can be used to compare the different performances of the users, such as to allow the users to asynchronously compete with each other in order to significantly improve their performance skills. Furthermore, the proposed system and method can be readily implemented on the existing infrastructure and may not require extensive set-up or instrumentation.

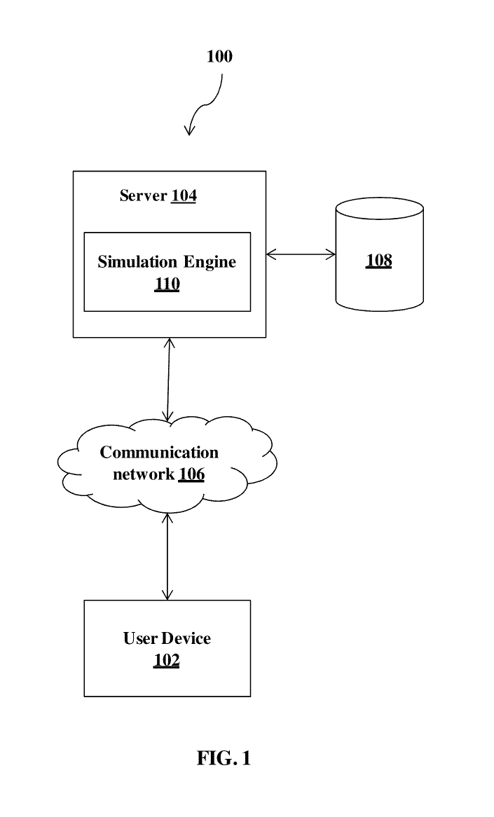

Referring now to the drawings, and more particularly to FIGS. 1 through 8, where similar reference characters denote corresponding features consistently throughout the figures, there are shown embodiments.

FIG. 1 is a diagram that illustrates generally, among other things, a high level architecture of a system 100 in which the present invention is embodied, according to embodiments as disclosed herein. In an embodiment, the system 100 includes one or more user devices 102 (hereafter referred as user device 102) and a server 104 communicating among each other over a communication network 106. In an embodiment, the communication network 106 described herein can include for example, but not limited to, wireless network, global system for mobile communication (GSM) network, cellular network, radio-frequency network, local, area network, wide area network, Near-Field communication (NFC) network, Bluetooth network, combination thereof, or any other network. Additionally, the communication network 106 can employ any type of communication protocol, including, but not limited to, Ethernet, token-ring, IEEE 802.x, cellular protocols, and the like.

In an embodiment, the user device 102 described herein can be any type of computing device such as for example, but not limited to, a computer, a laptop, a game console, a medical display device, a television, a portable game device, a cell phone, a smart phone, a tablet, a home appliance, a processor-enabled toy, a simulation controller, a personal digital assistance, a communicator, or any other device capable of accessing a performance skill enhancement application from the server 104. The term “performance skill” described herein can include for example, but not limited to, brain-based processing skill, perceptual skill, auditory skill, cognitive skills, and the like skills of the user. The performance skill enhancement application can be a web application configured to include various instructions and subroutines, which when executed the system 100 performs various operations, some or all of which may effectuate methods described herein. Each user device 102 can be associated with a user using the performance skill enhancement application to enhance their performance skills.

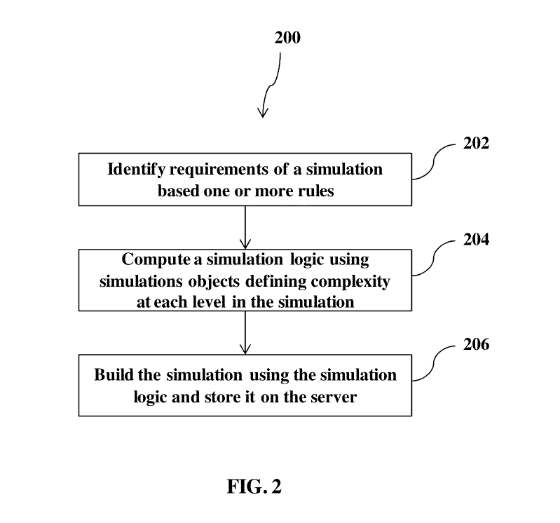

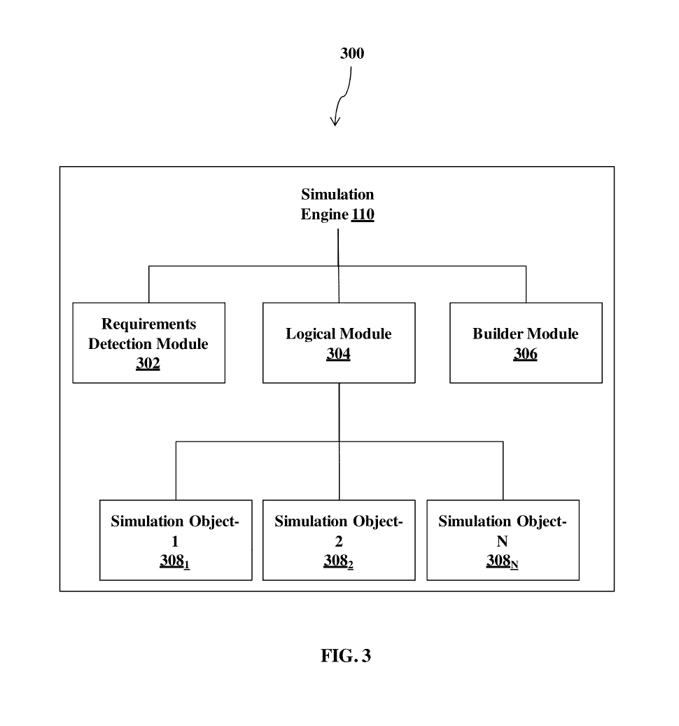

In an embodiment, the server 104 described herein can be any type of computing device including, but not limited to, a server, a desktop computer, a laptop computer, a handheld computer, a game console, simulation controller, a tablet, and the like. The server 104 can be configured to include or coupled to a database 108 including data related to the performance skill enhancement application. The database 108 can be configured to store performance data related to the performance of an individual user, or the performance of a group of users. Further, the server 104 can include a simulation engine 110 configured to dynamically create a plurality of simulations including a plurality of levels corresponding to the user curricular activities. The term “curricular activities” describes the activities, exercises, or tasks, performed by the user in real-world. Unlike conventional system, each level of the simulations can represent curricular activity or concept, such as to effectively enhance the user ability to perform a particular task in real-time. Further, the operations performed by the simulation engine 110 to dynamically create each simulation are described in conjunction with the FIG. 2. Furthermore, the various operations performed by the system 100 for assessing, training, and improving the performance skills of the user using the simulations based curricular mapping are described in conjunction with the FIGS. 3 through 8.

Although not shown, the user device 102 and the server 104, in some embodiments, can be the same device. In such an embodiment, the application and the database 108 may reside on the same device so that communication over an external communication network 106 is not needed. Though the FIG. 1 shows only one user device 102 and server 104 communicating among each other over the communication network 106 but, it is to be understood that another exemplary embodiment is not limited thereto. Further, the system 100 can include any number of user devices and servers along with other hardware or software components communicating with each other over the communication network. For example, the component can be, but not limited to, a process running in the controller or processor, an object, an executable process, a thread of execution, a program, or a computer. By way of illustration, both an application running on a device and the device itself can be a component.

FIG. 2 is a flow chart that illustrates a method 200 for dynamically creating the simulations on the server 104, according to embodiments as disclosed herein. In an embodiment, the simulations described herein can include for example, but not limited to, memory-based simulations, speed-based simulations, visual-based simulations, focus-based simulations, attention-based simulations, linguistics-based simulations, problem solving-based simulations, auditory-based simulations, and the like. At step 202, the method 200 includes identifying requirements of a simulation based one or more rules. In an embodiment, the one or more rules can be defined such as to determine the various requirements of the simulation to assess, train, and enhance the performance, to provide recommendations to the user, and the like. The method 200 includes allowing the simulation engine 110 to run one or more rules to identify the requirements of the simulation. For example, the rules may be used to define questions and answers that need to be embedded in the simulation, the number of questions that needs to be embedded in the simulation, randomizing the questions, time set for the whole simulation, and the like. In an embodiment, the one or more rules can include such as for example, but not limited to, unidirectional rules, bidirectional rules, generalized rules including multi-way rules, rules among simulations, rules among different levels, rules for computing the performance of the user at various level and accordingly generate other simulations, rules for recommendations, rules for comparison of performances, rules with weight factors, rules with priorities, un-weighted, un-prioritized rules, and the like. Such rules can be derived from, for example, but not limited to, automatic generation machine learning, automatic generation using a generic algorithm, automatic generation using a neutral network, automatic generation using a rule inference system, data mining, generation using a preset list of simulations, and the like.

In an embodiment, at step 204, the method 200 includes computing a simulation logic using one or more simulation objects, each defining complexity at each level in the simulation. Unlike conventional system, each level of the simulation includes the user curricular activity or concept, such as to effectively enhance the user ability to perform a particular task in real-time. Typically, undergoing or organizing the simulations plays significant role in improving the performance skills of the user in order to perform trained or untrained tasks in real-world, the use of the curricular activities mapping in the simulation can effectively improve the brain-based processing skill, perceptual skill, auditory skill, cognitive skills, and the like skills of the user in performing the real-world tasks. In an embodiment, at step 206, the method 200 includes building the simulation using the simulation logic and storing it on the server 104. The simulation engine 110 can be configured to build the simulations using the simulation logic indicating the complexity involved in each level. Further, the server 104 can be configured to store the simulations in the database 108. An example illustration of various modules used by the method 200 is described in conjunction with the FIG. 3.

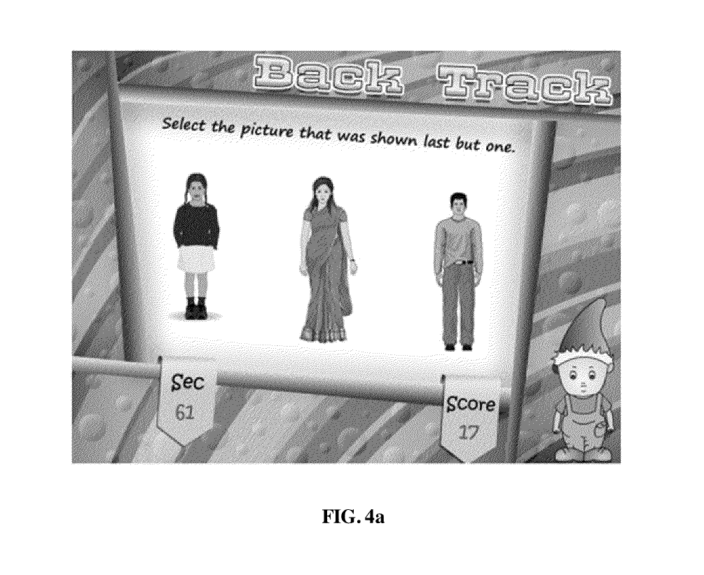

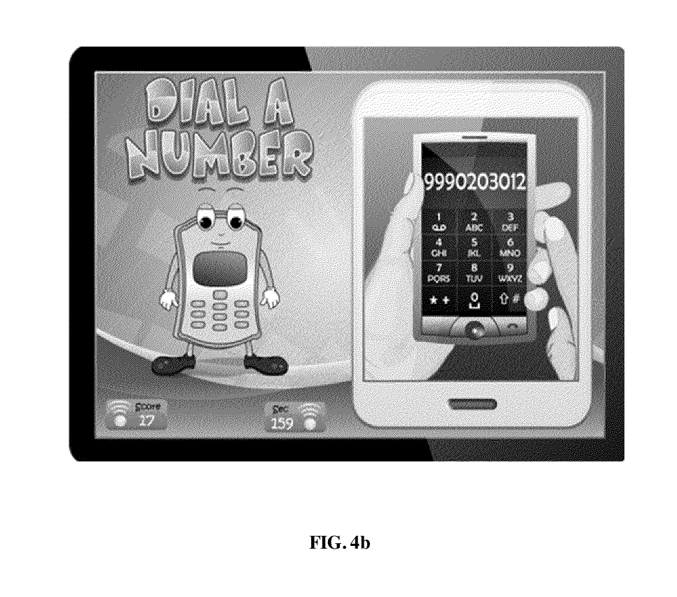

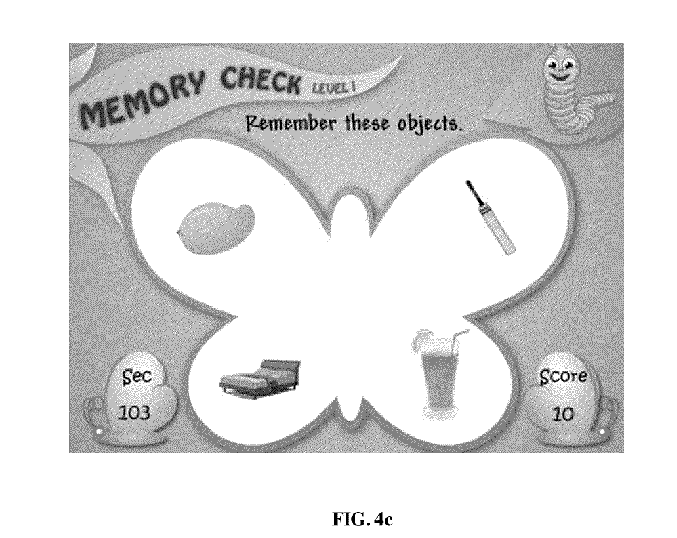

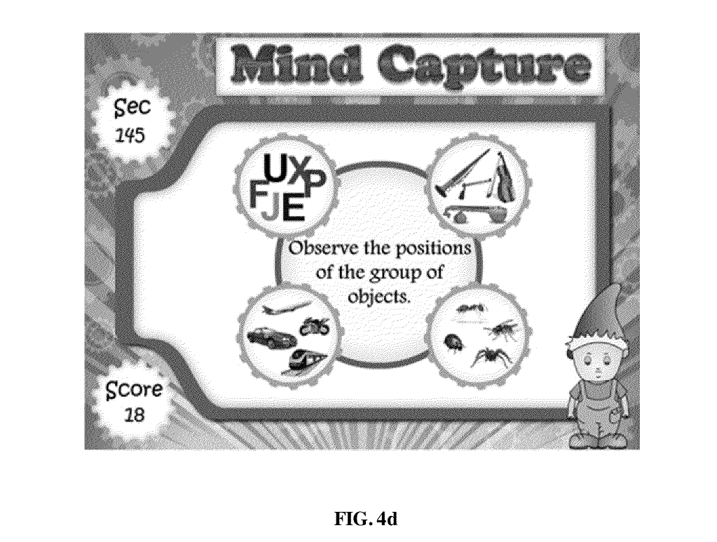

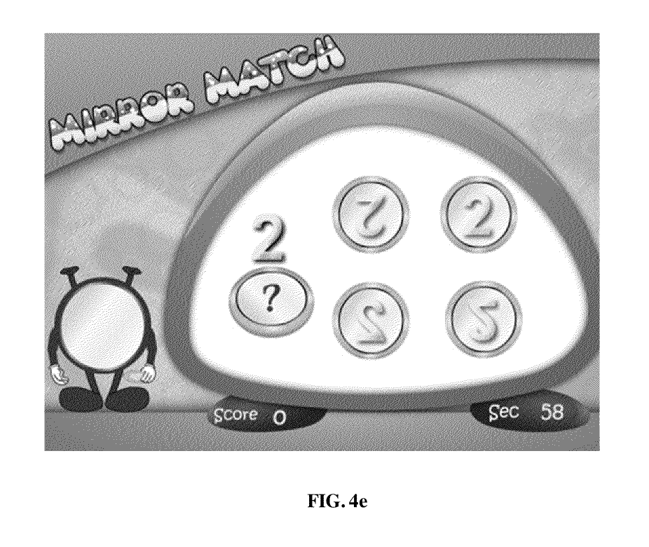

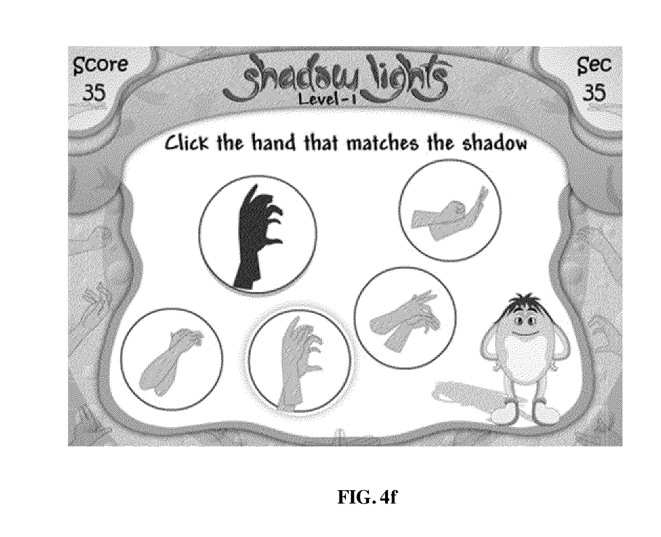

FIG. 3 is an example illustration 300 various modules used by the method 200 as described in the FIG. 2, according to embodiments as disclosed herein. In an embodiment, as show in the FIG. 3, the simulation engine 110 can be configured to include three modules namely, requirements detection module 302, logical module 304, and builder module 306, respectively. The requirements detection module 302 can identify the requirements of the simulations based on the one or more rules. The logical module 304 can be configured to include one or more simulation objects 308_{1-N} used to compute the simulation logic defining the complexity at each level in the simulation. Further, the builder module 306 can be used to build the simulations using the simulation logic indicating the complexity involved in each level. Further, the server 104 can be configured to store the simulations in the database 108. Furthermore, some of the example simulations dynamically created using the simulation engine 110 are described in conjunction with the FIG. 4.

FIGS. 4a, 4b, 4c, 4d, 4e, and 4f are example illustrations showing some of the simulations dynamically created by the simulation engine 110, according to embodiments as disclosed herein. Unlike conventional system, each level of the simulations corresponds to the user curricular activity or concept, such as to effectively enhance the user ability to perform a particular task in real-world. As the simulations plays a significant role in improving the performance skills of the user for performing trained or untrained tasks in real-time, the use of the curricular activities mapping in the simulations can effectively improve the user performance skills. The example illustrations of the simulations shown in the FIGS. 4a, 4b, 4c, 4d, 4e, and 4f. The FIG. 4a illustrates an example a back track simulation corresponding to a real-world curricular activity or concept. Similarly, the FIG. 4b illustrates an example a dial a number simulation corresponding to a real-world curricular activity or concept. Similarly, the FIG. 4c illustrates an example a memory checking simulation leve-1 corresponding to a real-time curricular activity or concept. Similarly, the FIG. 4d illustrates an example a mind capture simulation corresponding to a real-world curricular activity or concept. Similarly, the FIG. 4e illustrates an example a mirror match simulation corresponding to a real-world curricular activity or concept. Similarly, the FIG. 4f illustrates an example a shadow light simulation corresponding to a real-world curricular activity or concept.

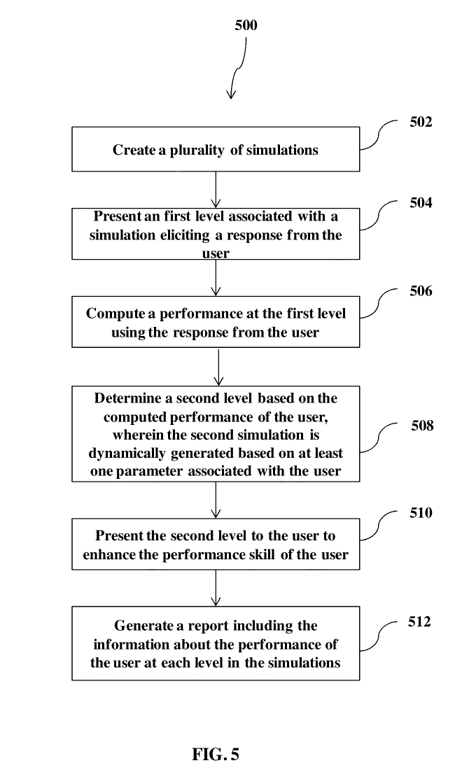

FIG. 5 is a flow chart that illustrates a method 500 for training a user based on curricular mapping , according to embodiments as disclosed herein. The various steps described in the method 500 are summarized into individual blocks where some of the steps can be performed by the user device 102, the server 104, the user, and the like. In an embodiment, at step 502, the method 500 includes creating a plurality of simulations, where each simulation includes one or more levels corresponding to the user curricular activity or concept. At step 504, the method 500 includes presenting an first level associated with a simulation eliciting a response from the user. In an embodiment, the first level described herein can be the initial level of the simulation or other successive levels to the last qualified level of the user. Each level may elicit a response from the user at a specific instance in the simulation. For example a question or a set of questions can be presented to the user asking information about the visuals presented in that level of the simulation. The user can provide the response in any form using any input means.

In an embodiment, at step 506, the method 500 includes computing a performance at the first level using the response from the user. In an embodiment, the performance can be measured based on Skill Performance Index (SPI), Brain Skill Power Index (BSPI), MOM, YOY Brain Skill Improvement Index (BSII), and the like. In an embodiment, the server 104 can be configured to compute the performance at each level based on, but not limited to, the time taken by the user to provide the respond, the number of questions answered by the user in a certain period of time, the correctness of the answers, and the like. For example, award full performance score, if a question is answered within 10 seconds, decrement the performance score by 1 for every additional second until 10 seconds, award a default performance score of 2 for a correct answer after the 10 seconds, 0 or invalid or wrong answer, total response time, and the like. The performance can be the sum of the time taken for each response received from the user, correctness of the response, number of responses received, and the like.

At step 508, the method 500 includes determining a second level associated with the simulation based on the computed performance of the user. The server 104 can be configured to dynamically create the second level based at least one parameter associated with the user and the performance of the user in the first level. In an embodiment, the parameter can include for example, but not limited to, age, performance in different skills, current performance in each level of current simulation, performances in each level of other simulations, user interest, and the like. In an embodiment, the second level can be same as the first level determined based on the performance of the user. In an embodiment, the second level can be a different complex level compared to the initial level determined based on the performance of the user.

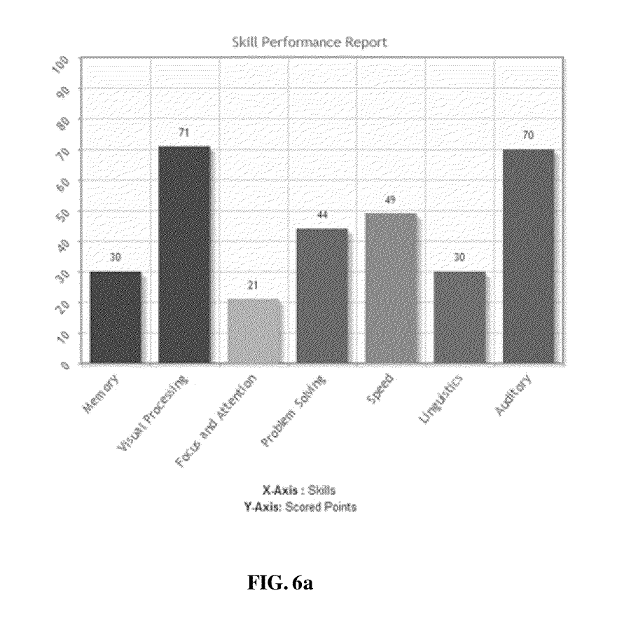

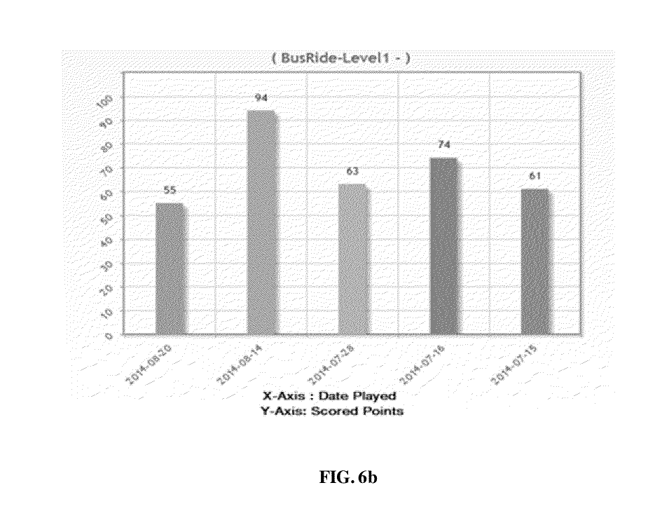

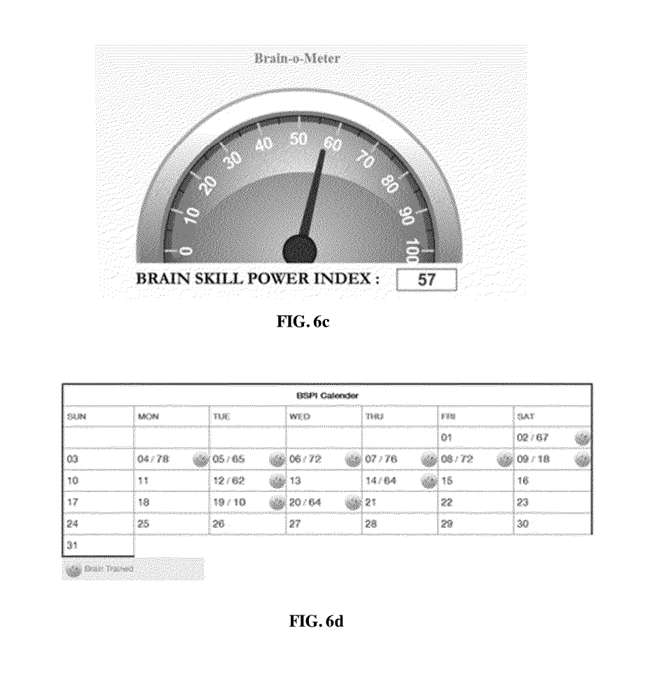

In an embodiment, at step 510, the method 500 includes presenting the second level to the user to enhance the performance skill of the user. Each level includes different simulation logic with variations to enable the user to think and analyze multiple viewpoints of real-life scenarios. The server 104 can be configured to allow the user to play different levels of the simulations to enhance the performance skills. As the user undergoes the different levels of the simulations over a period of time, there can be a significant improvement in the user accuracy, speed of calculations, analysis power, alertness, concentration, efficiency, and the like in performing the trained or untrained tasks in real-world. Further, at step 512, the method 500 includes generating a report including the information about the performance of the user at each level in the simulations. An example illustration of the report is described in conjunction with the FIG. 6.

FIGS. 6a, 6b, 6c, and 6d are example illustrations of the report generated for the simulations played by the user, according to embodiments as disclosed herein. The FIG. 6a shows a graphical representation of the performance skill of a user for last 10 times of play. Various skills are represented on X-axis represents and performance score achieved by the user in each skill is represented on Y-axis. The FIG. 6b shows another graphical representation of the performance skill of a user for last times of play. The x-axis represents date of play and the y-axis represents performance score achieved by the user. The user can use the report to analyze the performance in each simulation and try improving the skills accordingly by playing the different levels of the simulation. Similarly, the FIG. 6c shows an example BSPI associated with the user. Similarly, the FIG. 6d shows an example BSPI calendar associated with the user.

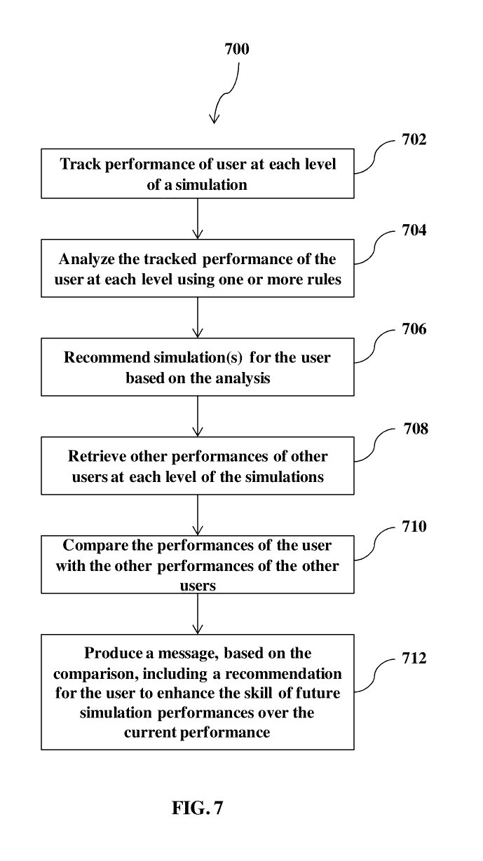

FIG. 7 is a flow chart that illustrates a method 700 for providing recommendations and allowing users to asynchronously compete with each other, according to embodiments as disclosed herein. In an embodiment, at step 702, the method 700 includes tracking the performance of the user at each level of the simulations. The server 104 can be configured to track the performance skill of the user at each level in the simulations. At step 704, the method 700 includes analyzing the tracked performance of the user at each level using the one or more rules. At step 706, the method 700 includes recommending simulation(s) for the user based on the analysis. For example, the server 104 can be configured to analyze the tracked performance using the one or more rules and provide simulation recommendations to the user for playing the simulations that the user did not played yet or did played but the performance is poor. For example, the server 104 can execute the rules to analyze that the user who played well in problem solving simulations can likely be able to perform well even in analysis or memory-based simulation. The analysis of the tracked performance can allow the users to identify and improve the performance skills in the areas where they might be poor. For example, a teacher or parent may identify that a child who does not score high in curricular but does well in a particular cognitive skill area is not a dull child. There could be other factors which causes this gap and can be addressed by the teacher or parent.

Unlike conventional systems, the sever 104 can be configured to identify a new simulation pack each day for the user, from the master set of simulations based on the performance of the user. Each simulation pack may be defined based on the number of simulations for each skill of the user. Each game can be defined number of times of play such as to efficiently train and enhance the performance skills of the user.

In an embodiment, at step 708, the method 700 includes retrieving other performance of one or more other users at each level of the simulation. At step 710, the method 700 includes comparing the performances of the user with the other performances of the other users. As the simulations can provide an enjoyable and socially connected competitive experience for a group of individuals, it is important to compare the performances of different users to improve cognitive functions and achieve an improvised performance in competition to others. The server 104 can be configured to retrieve the other performance of the other users and compare it with the other performances of the other user at each level of the simulations. At step 712, the method 700 includes producing a message, based on the comparison, including a recommendation for the user to enhance the skill of future simulation performances over the current performance. Based on the comparison, the server 104 can be configured to provide recommendations to the user to enhance the skill of future simulations performances. The different performances of the users are compared to allow the users to asynchronously compete with each other in order to significantly improve their performance skills. The user can view the other performances of other users and set a target or goal to compete with the other users.

The various actions, units, steps, blocks, or acts described in the methods herein can be performed in the order presented, in a different order, simultaneously, or a combination thereof. Further, in some embodiments, some of the actions, units, steps, blocks, or acts listed in the methods may be omitted, added, skipped, or modified without departing from the scope of the invention. Further, the methods and other description described herein provides a basis for a control program which can be easily implemented using a microprocessor, microcontroller, or a combination thereof.

The various components, labels, elements, modules, engines, devices, and the like described with respect to the FIGS. 1 through 8 are only for illustrative purpose and does not limit the scope of the invention. Furthermore, it is understood that any other components, labels, elements, modules, engines, devices, and the like can be used to perform the same, similar, or substantially similar operations without departing from the scope of the invention.

Though the above description is described with respect to assessing, training, and enhancing the performance skills of a user in performing a task, a person skilled in art will appreciate that the system and method can also be used to treat mild cognitive impairment, mild cognitive disorder, organic brain syndrome, and the like. Further, the system and method can be used to assess, train, and enhance the performance skills of employees in an organization, adults, children's to perform well in their curricular activities, and the like.

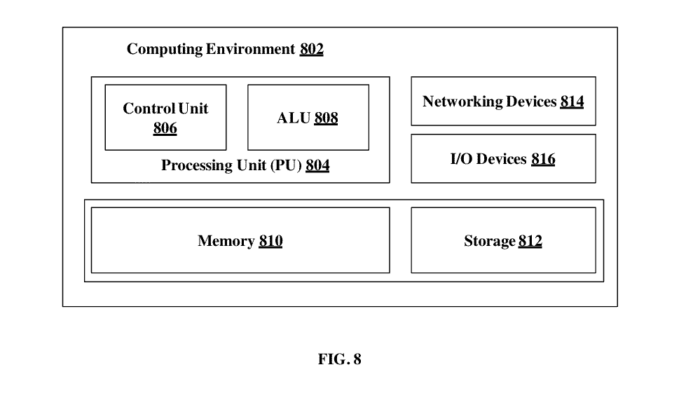

FIG. 8 illustrates a computing environment 802 implementing the method and systems as disclosed in the embodiments herein. As depicted the computing environment 802 comprises at least one processing unit 804 that is equipped with a control unit 806 and an Arithmetic Logic Unit (ALU) 808, a memory 810, a storage unit 812, plurality of networking devices 814 and a plurality Input output (I/O) devices 816. The processing unit 804 is responsible for processing the instructions of the algorithm. The processing unit 804 receives commands from the control unit 806 in order to perform its processing. Further, any logical and arithmetic operations involved in the execution of the instructions are computed with the help of the ALU 808.

The overall computing environment 802 can be composed of multiple homogeneous or heterogeneous cores, multiple CPUs of different kinds, special media and other accelerators. The processing unit 804 is responsible for processing the instructions of the algorithm. Further, the plurality of processing units 804 may be located on a single chip or over multiple chips.

The algorithm comprising of instructions and codes required for the implementation are stored in either the memory unit 810 or the storage 812 or both. At the time of execution, the instructions may be fetched from the corresponding memory 810 and/or storage 812, and executed by the processing unit 804. In case of any hardware implementations various networking devices 814 or external I/O devices 816 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 1 through 8 include blocks, steps, operations, and acts, which can be at least one of a hardware device, or a combination of the hardware device and software module.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for training a user based on curricular mapping, the method comprising:
presenting a first level of a first simulation eliciting a response from said user, wherein said first level corresponds to at least one curricular activity in real-world for which the training is desired;
computing a performance data of said user for said first level using said response from said user;
determining a second level based on said computed performance data, wherein said second level is dynamically created based on at least one parameter associated with said user; and
presenting said second level to said user, wherein said second level is associated with at least one of said first simulation and a second simulation.

2. The method of claim 1, wherein dynamically creating said second level based on at least one said parameter associated with said user comprises:
identifying requirements based on at least one rules and at least one parameter assonated with said user;
computing at least one simulation logic using at least one simulation object defining complexity at each said level in each said simulation, wherein each said level corresponds to at least one said curricular activity of real-world; and
creating each said level using said at least one simulation logic.

3. The method of claim 1, wherein said method further comprises:
tracking said performance data of said user at each said level associated with at least one said simulation;
analyzing said tracked performance data of said user at each level using at least one said rules; and
recommending at least one simulation for said user based on said analysis.

4. The method of claim 1, wherein said method further comprises:
retrieving said performance data of said user at each said level associated with said at least one simulation;
retrieving other performance data of at least one other user at each said level associated with said same at least one simulation;
comparing said performance data of said user with said other performance data of said at least one other user; and
dynamically generating a message based on said comparison, wherein said message comprising a recommendation for said user to enhance performance data skill of other simulation over said performance data.

5. The method of claim 1, wherein said second level is same as said first level based on said computed performance data and said at least one parameter associated with said user.

6. The method of claim 1, wherein said second level is a different complex level compared to said first level based on said computed performance data and said at least one parameter associated with said user.

7. A system for training a user based on curricular mapping, the system comprising a simulation engine configured to:
present a first level of a first simulation eliciting a response from said user, wherein said first level corresponds to at least one curricular activity in real-world for which training is desired;
compute a performance data of said user for said first level using said response from said user;
determine a second level based on said computed performance data, wherein said second level is dynamically created based on at least one parameter associated with said user;
present said second level to said user, wherein said second level is associated with at least one of said first simulation and a second simulation.

8. The system of claim 7, wherein dynamically create said second level based on at least one said parameter associated with said user comprises:
identify requirements based on at least one rules and at least one parameter assonated with said user;
compute at least one simulation logic using at least one simulation object defining complexity at each said level in each said simulation, wherein each said level corresponds to at least one said curricular activity of real-world; and
create each said level using said at least one simulation logic.

9. The system of claim 7, wherein said simulation engine is further configured to:
track said performance data of said user at each said level associated with at least one said simulation;
analyze said tracked performance data of said user at each level using at least one said rules; and
recommend at least one simulation for said user based on said analysis.

10. The system of claim 7, wherein said simulation engine is further configured to:
retrieve said performance data of said user at each said level associated with said at least one simulation;
retrieve other performance data of at least one other user at each said level associated with said same at least one simulation;
compare said performance data of said user with said other performance data of said at least one other user; and
dynamically generate a message based on said comparison, wherein said message comprising a recommendation for said user to enhance performance data skill of other simulation over said performance data.

11. The system of claim 7, wherein said second level is same as said first level based on said computed performance data and said at least one parameter associated with said user.

12. The system of claim 7, wherein said second level is a different complex level compared to said first level based on said computed performance data and said at least one parameter associated with said user.

13. A computer program product comprising a computer executable program code recorded on a computer readable non-transitory storage medium, wherein said computer executable program code when executed causing the actions including:
presenting a first level of a first simulation eliciting a response from a user, wherein said first level corresponds to at least one curricular activity in real-world for which training is desired;
computing a performance data of said user for said first level using said response from said user;
determining a second level based on said computed performance data, wherein said second level is dynamically created based on at least one parameter associated with said user;
presenting said second level to said user, wherein said second level is associated with at least one of said first simulation and a second simulation.

14. The computer program product of claim 12, wherein dynamically creating said second level based on at least one said parameter associated with said user comprises:
identifying requirements based on at least one rules and at least one parameter assonated with said user;
computing at least one simulation logic using at least one simulation object defining complexity at each said level in each said simulation, wherein each said level corresponds to at least one said curricular activity of real-world; and
creating each said level using said at least one simulation logic.

15. The computer program product of claim 12, wherein said computer executable program code when executed causing the actions including:
tracking said performance data of said user at each said level associated with at least one said simulation;
analyzing said tracked performance data of said user at each level using at least one said rules; and
recommending at least one simulation for said user based on said analysis.

16. The computer program product of claim 12, wherein said computer executable program code when executed causing the actions including:
retrieving said performance data of said user at each said level associated with said at least one simulation;
retrieving other performance data of at least one other user at each said level associated with said same at least one simulation;
comparing said performance data of said user with said other performance data of said at least one other user; and
dynamically generating a message based on said comparison, wherein said message comprising a recommendation for said user to enhance performance data skill of other simulation over said performance data.

17. The computer program product of claim 12, wherein said second level is same as said first level based on said computed performance data and said at least one parameter associated with said user.

18. The computer program product of claim 12, wherein said second level is a different complex level compared to said first level based on said computed performance data and said at least one parameter associated with said user.
